(19) United States
(12) Patent Application Publication
(10) Pub. No.: US 2010/0184483 A1
(43) Pub. Date: Jul. 22, 2010

(54) HANDHELD ELECTRONIC DEVICE

(75) Inventors: Yi-Min Kao, Taipei (TW); Qi Liu, Shanghai (CN)

Correspondence Address: RABIN & Berdo, PC, 1101 14TH STREET, NW, SUITE 500, WASHINGTON, DC, 20005, US

(73) Assignee: Inventec Appliances Corp., Taipei (TW)

(21) Appl. No.: 12/648,606

(22) Filed: Dec. 29, 2009

(30) Foreign Application Priority Data
Jan. 20, 2009 (TW) 098201090

(51) Int. Cl. H04M 1/00; G09G 5/00; G06K 9/00

(52) U.S. Cl. 455/566; 345/156; 382/187

(57) ABSTRACT

A handheld electronic device including a data input module, a database and a display unit is provided. The data input module includes an image fetching unit and a pattern recognition unit. The image fetching unit is for fetching a pattern of an external object to produce image data. The pattern recognition unit is for transferring the image data to input data. The database is for storing several storage data items. Each storage data item has subject information. When the input data is related to one of the storage data items, the display unit is for displaying navigation information generated according to the subject information of the related storage data item.

This application claims the benefit of Taiwan application Serial No. 98201090, filed Jan. 20, 2009, the subject matter of which is incorporated herein by reference.

### BACKGROUND OF THE INVENTION

1. Field of the Invention

The invention relates in general to a handheld electronic device, and more particularly to a handheld electronic device which generates input data according to a fetched pattern.

2. Description of the Related Art

Generally speaking, handheld electronic devices provide keyboards or touch screens for users to operate and input information. Let the handheld electronic device having navigation function be taken for example. If the user would like to obtain navigation information corresponding to a destination, the user has to input the address of the destination by pressing the keyboard with fingers or writing on the touch screen with a stylus.

As the market demand for the handheld electronic device is directed towards light, weight and miniaturization, the keyboard of the handheld electronic device also becomes smaller. Thus, when the user tries to press a key with his or her finger, other key or keys may be touched unintentionally, and this is indeed very inconvenient for operation. On the other hand, if the script written by the user with a stylus is not recognizable to the handheld electronic device, the user has to re-write and input again, not only decreasing the efficiency of data input but also making the user frustrated during the operation.

### SUMMARY OF THE INVENTION

The invention is directed to a handheld electronic device. A pattern of an external object is fetched and used as input data, so that the user can conveniently operate the handheld electronic device to obtain corresponding navigation information.

According to a first aspect of the present invention, a handheld electronic device including a data input module, a database and a display unit is provided. The data input module includes an image fetching unit and a pattern recognition unit. The image fetching unit is for fetching a pattern of an external object to produce image data. The pattern recognition unit transfers the image data to input data. The database is for storing several storage data items, each having subject information. When the input data is related to one of the storage data items, the display unit is for displaying navigation information generated according to the subject information of the related storage data item.

The invention will become apparent from the following detailed description of the preferred but non-limiting embodiments. The following description is made with reference to the accompanying drawings.

### BRIEF DESCRIPTION OF THE DRAWINGS

FIG. 1 shows a handheld electronic device, an external object and an external server according to an embodiment of the invention; and

FIG. 2 shows an example of a simulation diagram of a display unit of FIG. 1.

### DETAILED DESCRIPTION OF THE INVENTION

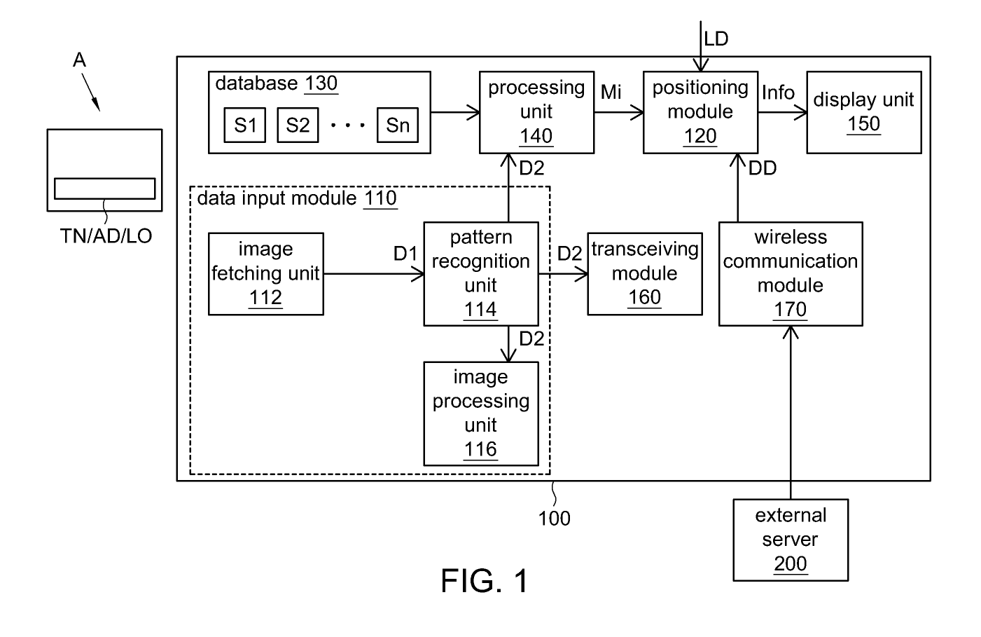

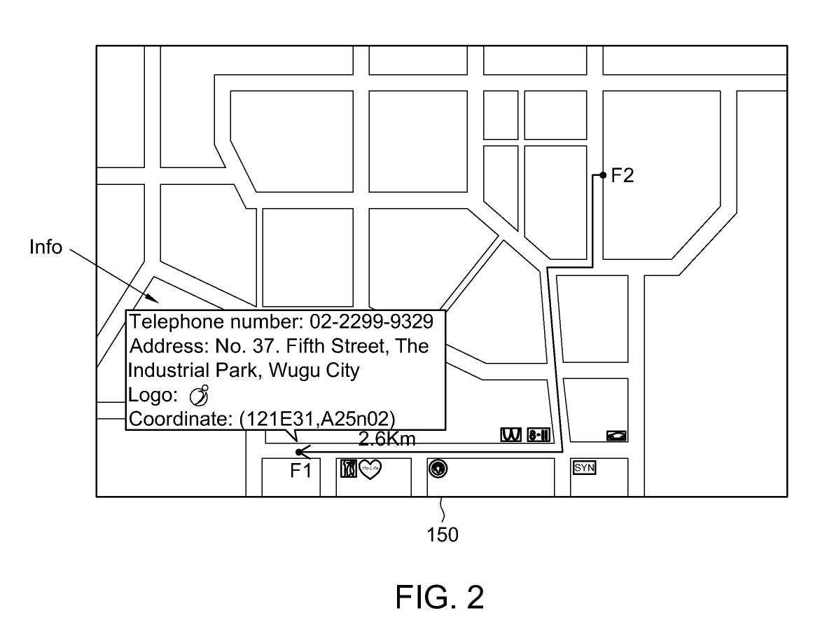

Refer to FIG. 1 and FIG. 2 at the same time. FIG. 1 shows a handheld electronic device, an external object and an external server according to an embodiment of the invention. FIG. 2 shows an example of a simulation diagram of a display unit of FIG. 1. The handheld electronic device 100, which can be a mobile phone or a PDA, includes a data input module 110, a database 130 and a display unit 150. The data input module 110 includes an image fetching unit 112 and a pattern recognition unit 114. The image fetching unit 112, which can be a camera or a video recorder, is for fetching a pattern of an external object A to produce image data D1. The external object A can be a name card, and the pattern can be a telephone number pattern TN, an address pattern AD or a logo pattern LO on the name card. The pattern recognition unit 114 transfers the image data D1 to input data D2 corresponding to a destination F1.

The database 130 is for storing several storage data items S1˜Sn. Each storage data item S1˜Sn includes subject information M1˜Mn respectively corresponding to a subject. If the input data D2 is related to one of the storage data items S1˜Sn, such as the storage data item Si for example, that is, the subject corresponding to the storage data item Si is the destination F1, then the display unit 150 is for displaying navigation information Info. The navigation information Info is generated according to the subject information Mi of the storage data item Si.

Thus, the user only needs to place the pattern of the external object A to be near the handheld electronic device 100, then the handheld electronic device 100 obtains the image data D1 by way of image fetching, and transfers the image data D1 to the input data D2, and retrieve the subject information Mi related to the input data D2 from the database 130 so as to generate the navigation information Info. Compared with the conventional handheld electronic device, the handheld electronic device 100 according to an embodiment of the invention does not require the user to input by way of key input or handwriting, hence providing more convenience to the user.

In the present embodiment of the invention, the pattern fetched by the image fetching unit 112 is a single type of data of the external object A. That is, the pattern is one of a telephone number pattern TN, an address pattern AD and a logo pattern LO on the name card. However, the invention is not limited thereto. In other embodiments, the pattern fetched by the image fetching unit 112 can be multiple types of data of the external object A. That is, the pattern includes at least two of the telephone number pattern TN, the address pattern AD and the logo pattern LO on the name card. Furthermore, after the image fetching unit 112 fetches a pattern having multiple types of data, the display unit 150 displays the pattern, and the display unit 150 further provides a selection window (not illustrated) for the user to select at least a portion of the pattern (for example, the telephone number pattern TN, the address pattern AD or the logo pattern LO) to produce the image data D1.

In the present embodiment of the invention, the handheld electronic device 100 further includes a processing unit 140 for determining whether the input data D2 is related to any one of the storage data items S1˜Sn, and determining whether to enable the display unit 150 to display the navigation information Info.

In the present embodiment of the invention, as indicated in FIG. 2, the navigation information Info is coordinate information, such as coordinate (121E31, 25NO2), or peripheral entertainment information, such as the symbols of airport, convenience store, car park and so on, of the destination F1.

Moreover, the handheld electronic device 100 further includes a positioning module 120, which can be a global position system (GPS) module. The positioning module 120 is for obtaining location information LD of the handheld electronic device 100, wherein the location information LD corresponds to a current location F2. Under such circumstances, the navigation information Info is generated according to the subject information Mi of the storage data item Si and the location information LD, and can further include the distance and the path from the current location F2 of the handheld electronic device 100 to the destination F1.

As disclosed above, the pattern of the external object A can be a telephone number pattern TN, an address pattern AD or a logo pattern LO, respectively exemplified below. Firstly, let the pattern be the telephone number pattern TN. The image fetching unit 112 fetches the telephone number pattern TN to obtain image data D1 whose format can be PNG format, BMP format or GIF format. The pattern recognition unit 114 transfers the image data D1 to input data D2 corresponding to the telephone number pattern TN, wherein the input data D2 corresponds to input telephone number data of the destination F1 such as “02-2299-9329”. Each of the storage data items S1˜Sn further includes subject telephone number data and respectively records the telephone number of the corresponding subject. The processing unit 140 matches the input telephone number data in these subject telephone number data, and determines whether the input telephone number data is related to these subject telephone number data so as to determine whether the input data D2 is related to one of the storage data items S1˜Sn.

In the above exemplification, the handheld electronic device 100 further includes a transceiving module 160 as indicated in FIG. 1. When the processing unit 140 determines that the input data D2 is related to one of the storage data items S1˜Sn (that is, the input telephone number data is related to one of these subject telephone number data), the transceiving module 160 emits a call to a reception end corresponding to the input telephone number data for the user to communicate with the reception end.

Next, let the pattern be the address pattern AD. The image fetching unit 112 fetches an address pattern AD to obtain image data D1 whose format can be PNG format, BMP format or GIF format. The pattern recognition unit 114 transfers the image data D1 to input data D2 corresponding to the address pattern AD, wherein the input data D2 corresponds to input address data of the destination F1 such as “No. 37. Fifth Street, The Industrial Park, Wugu City”. Each of the storage data items S1˜Sn further includes a subject address data and respectively records the address of the corresponding subject. The processing unit 140 matches the input address data in these subject address data, and determine whether the input address data is related to these subject address data so as to determine whether the input data D2 is related to one of the storage data items S1˜Sn.

Then, let the pattern be the logo pattern LO. The image fetching unit 112 fetches the logo pattern LO to obtain image data D1 whose format can be PNG format, BMP format or GIF format. The pattern recognition unit 114 transfers the image data D1 to input data D2 corresponding to the logo pattern LO, wherein the input data D2 corresponds to input logo data of the destination F1 such as the logo of the business located at the destination F1. Each of the storage data items S1˜Sn further includes subject logo data and respectively records the logo of the corresponding subject. The processing unit 140 matches the input logo data in these subject logo data, and determine whether the input logo data is related to these subject logo data so as to determine whether the input data D2 is related to one of the storage data items S1˜Sn.

In the above exemplification, the data input module 110 further includes an image processing unit 116 for editing the input logo data. Thus, the user can apply further processing to the edited input logo data. For example, the edited input logo data is saved to the database 130.

Preferably, the handheld electronic device 100 further includes a wireless communication module 170, which can be a Bluetooth module. When the processing unit 140 determines that the input data D2 is not related to any one of the storage data items S1˜Sn, the wireless communication module 170 is for conducting wireless transmission with an external server 200 to obtain download information DD related to the input data D2. Under such circumstances, the navigation information Info is generated by the GPS module 120 according to the download information DD and the location information LD. Thus, despite all of the storage data items S1˜Sn are not related to the input data D2, the handheld electronic device 100 still can obtain the download information DD related to the input data D2 from the external server 200 via the wireless communication module 170 and provides the download information DD for the GPS module 120 to generate navigation information Info.

Besides, when processing unit 140 determines that the input data D2 is not related to any of the storage data items S1˜Sn, the processing unit 140 further saves the input data D2 to the database 130. Or, when the processing unit 140 determines that the input data D2 is not related to any of the storage data items S1˜Sn, the processing unit 140 further edits one of the storage data items S1˜Sn according to the input data D2, and provides the edited storage data item for the user to update the to-be-searched input data D2 to the database 130.

According to the handheld electronic device disclosed in the above embodiment of the invention, a pattern of an external object is fetched and used as input data, so that the user can conveniently operate the handheld electronic device to obtain the corresponding navigation information. The pattern can be a telephone number pattern, an address pattern or a logo pattern on a name card. As the convenience of operation is increased, the user the user can set the handheld electronic device without complicated process of key input or hand writing, not only increasing the efficiency of generating the input data but also avoiding recognition error arising during the input by hand writing.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A handheld electronic device, comprising:
a data input module, comprising:
an image fetching unit for fetching a pattern of an external object to produce image data; and
a pattern recognition unit for transferring the image data to input data;
a database for storing a plurality of storage data items, each comprising subject information; and
a display unit, wherein when the input data is related to one of the storage data items, the display unit is used for displaying navigation information generated according to the subject information of the related storage data item.

2. The handheld electronic device according to claim 1, further comprising:
a positioning module for obtaining location information of the handheld electronic device;
wherein, the navigation information is generated according to the subject information of the related storage data item and the location information.

3. The handheld electronic device according to claim 2, wherein the positioning module is a global position system (GPS) module.

4. The handheld electronic device according to claim 1, wherein the display unit is further for displaying the pattern fetched by the image fetching unit, and the display unit is further for providing a selection window for selecting at least a portion of the pattern to produce the image data.

5. The handheld electronic device according to claim 1, wherein the related storage data item corresponds to a destination, and the navigation information is coordinate information or peripheral entertainment information of the destination.

6. The handheld electronic device according to claim 1, further comprising:
a wireless communication module for conducting wireless transmission with an external server to obtain download information that is related to the input data when the input data is not related to any one of the storage data items;
wherein, the navigation information is generated according to the download information.

7. The handheld electronic device according to claim 6, wherein the wireless communication module is a Bluetooth module.

8. The handheld electronic device according to claim 1, further comprising:
a processing unit for determining whether the input data is related to one of the storage data items.

9. The handheld electronic device according to claim 8, wherein when the processing unit determines that the input data is not related to any one of the storage data items, the processing unit is further for saving the input data to the database.

10. The handheld electronic device according to claim 8, wherein when the processing unit determines that the input data is not related to any one of the storage data items, the processing unit is further for editing one of the storage data item according to the input data.

11. The handheld electronic device according to claim 8, wherein the pattern of the external object is a telephone number pattern, the input data is input telephone number data, each storage data item further comprises subject telephone number data, the processing unit matches the input telephone number data in these subject telephone number data to determine whether the input data is related to one of the storage data items.

12. The handheld electronic device according to claim 11, further comprising:
a transceiving module for emitting a call to a reception end corresponding to the input telephone number data when the processing unit determines that the input data is related to one of the storage data items.

13. The handheld electronic device according to claim 8, wherein the pattern of the external object is an address pattern, the input data is input address data, each storage data item further comprises subject address data, the processing unit matches the input address data in these subject address data to determine whether the input data is related to one of the storage data items.

14. The handheld electronic device according to claim 8, wherein the pattern of the external object is a logo pattern, the input data is input logo data, each storage data item further comprises subject logo data, the processing unit matches the input logo data in these subject logo data to determine whether the input data is related to one of the storage data items.

15. The handheld electronic device according to claim 14, wherein the data input module further comprises:
an image processing unit for editing the input logo data.
